(19) United States
(12) Patent Application Publication
(10) Pub. No.: US 2025/0062110 A1
(43) Pub. Date: Feb. 20, 2025

(54) A METHOD OF DETERMINING OPERATIONAL PARAMETERS OF A SPECTROMETER, A MASS SPECTROMETER AND COMPUTER SOFTWARE CONFIGURED TO PERFORM THE METHOD

(71) Applicant: Thermo Fisher Scientific (Bremen) GmbH, Bremen (DE)

(72) Inventors: Nils Stöbener, Bremen (DE); Johannes Schwieters, Bremen (DE); Issaku Kohl, Bremen (DE); Leanne Verster, Bremen (DE)

(73) Assignee: Thermo Fisher Scientific (Bremen) GmbH, Bremen (DE)

(21) Appl. No.: 18/721,477

(22) PCT Filed: Dec. 14, 2022
(86) PCT No.: PCT/EP2022/085943

§ 371 Date: Jun. 18, 2024

(30) Foreign Application Priority Data
Dec. 20, 2021 (GB) 2118517.8

(51) Int. Cl. H01J 49/28; H01J 49/00; H01J 49/14

(52) U.S. Cl. CPC H01J 49/28; H01J 49/0031; H01J 49/147

(57) ABSTRACT

Methods comprise introducing a gas sample having an ionisation potential below a first electron energy and above a second electron energy into an ion source and operating the ion source in the ON mode; measuring a signal produced by ionisation of the gas sample during a first time period; operating the ion source in the OFF mode during a second time period; determining, based on the signal measured during the first time period, an expected signal for ionisation of the gas sample during a third time period; operating the ion source in the ON mode and measuring a signal produced by ionisation of the gas sample during the third time period; calculating a deviation between the measured signal for the third time period and the expected signal for the third time period; and based on the deviation, adjusting one or more of the second set of operational parameters.

### TECHNICAL FIELD OF THE INVENTION

The invention relates to the field of static mass spectrometers and on the measurement of noble gas isotopes and isotope ratios using such instruments.

### BACKGROUND

Static mass spectrometers are used to measure the isotope ratios of noble gases, with the primary application being in the field of geochronology. In this context, the availability of sample material typically is very limited, requiring a different approach to sample introduction for these mass spectrometers as compared to standard gas isotope ratio MS. With the latter instruments, gas samples are continuously fed into the ion source over the measurement time, or even into waste while reference gases are measured. When the sample gas amounts are too small for that approach, static mass spectrometers come into play. Here, the total sample is administered into the ion source at once and then consumed by ionization, i.e., by its measurement. Before the sample is transferred into the ion source, all vacuum pumps are closed off, and even pressure gauges are turned off to avoid any sample consumption by processes other than ionization. During measurement, the sample is continuously depleted, resulting in an exponential decrease of the measured intensity, which is typically described as a function: f(t)=a exp (b t). Examples of static mass spectrometers include the Argus and Helix Multicollector instruments from Thermo Fisher, and instruments from other manufacturers, such as Nu Instruments or Isotopx.

A description of the Argus MC and the principles of static MS measurement can be found in Mark et al., Geochem. Geophys. Geosys., 2009, 10 (doi: 10.1029/2009GC002643).

FIG. 1 illustrates a simplified schematic of a static mass spectrometer. Sample gas is admitted into the ion source from a preparation device. Two valves allow for closing off the source against the preparation device and the ion pump.

One challenge faced in static mass spectrometry (static MS) is that after introduction, the sample gases need to equilibrate between the sample preparation device connected to the ion source and inside the ion source itself. As all parts of the instrument are kept under high vacuum, gas transport is solely driven by diffusion. As a consequence, it takes some time until a sample gas is isotopically equally distributed. This time can be in the range between 20 seconds and several minutes, depending on the type of gas (heavy gases diffusing slower). However, the ion source cannot be switched of during the equilibration phase. Therefore, a portion of the sample gas is consumed during the time that the gas is equilibrating. Longer equilibration times mean more complete equilibration, but higher sample consumption before the start of the actual measurement. As both the measured intensity and the isotope ratios change during the course of a measurement, initial parameters need to be calculated from the obtained data by extrapolation. The intensity at the beginning of the equilibration phase is calculated using the exponential function mentioned above and extrapolating back to the time when the sample inlet valve of the ion source is opened, which is denoted by to. Similarly, the isotope ratio of the sample at the beginning of the ionization can be obtained by linear extrapolation of the measured isotope ratios back to t₀.

While the procedure described above has been well established for decades, the available precision is limited because all measured data are obtained from a reduced small sample amount (because a proportion of the sample has been consumed during equilibration).

GB2551127 proposes to address this problem. Before the sample gas is introduced into the ion source, the electron energy is reduced below the ionization potential of the species of interest, avoiding its ionization. As an example, the first ionization potential for Argon is 15.8 eV, so adjusting the voltage between filament and box to 12 V prevents ionization of the sample. The electron energy is maintained at this reduced level until the gas is fully equilibrated and only then is increased above the first ionisation potential for the sample. Ionization and consumption of the sample therefore only begins after equilibration. No sample species are consumed before the actual measurement is started.

FIG. 2 illustrates a schematic of an ion source. Electrons are emitted from a filament via resistive heating (where a filament current I_{Fil} is applied to the filament). The electrons are accelerated into the Ionization Volume (“Box”), resulting in a predictable electron energy. Electrons impact in the trap causing a trap current I_{Trap}, which in turn is used to regulate I_{Fil}. Sample atoms/molecules are ionized in the box.

Some electrons will hit the box instead of the trap, resulting in a box current. Trap and box current combined are the source current I_{Source}, which may be employed alternatively to regulate the filament current.

One challenge with the practical implementation of GB2551127 is that reducing the electron energy also changes the number of electrons reaching the trap, and in a lower trap current. As a result, the filament current is increased, leading to a higher filament temperature. In the next step, the electron energy is set back to a higher value (sufficient for ionization). As the filament is still hot, this may result in a higher number of emitted electrons at different kinetic energies. Consequently, the ionization efficacy is different as compared to the conditions before reducing the electron energy. Over- or undershooting of the ion current is measured on the mass spectrometer after the electron energy is changed, eventually settling over time. Useful measurement cannot begin until the over-/undershooting has settled and the sample is consumed during this time. Therefore, some of the benefits of reducing the electron energy are lost.

To address this problem, GB2551127 proposes to measure the filament temperature and regulate the trap current based on the filament temperature. In this way, the filament temperature may be kept constant, independent of the electron energy. However, this proposal has several drawbacks.

Firstly, installation of a thermistor or thermocouple sensor inside the source to measure the filament temperature may either increase the volume of the source or increase the surface area of the volume (if a new component is added without increasing the volume). In static MS, ion sources are optimized for a small volume (and surface area) in order to obtain highest sensitivity. Therefore, increasing the source volume (or surface area) adversely affects sensitivity. Alternatively, using an (external) pyrometer for temperature measurement requires the installation of a window in the source, which requires significant changes in the source design and can introduce leaks in the source, which must maintain a high level of vacuum.

Second, the analytical performance of a static MS is adversely affected by regulating the filament current on filament temperature, rather than ion current. In order to ensure reliable and consistent signal measurement, ionisation conditions should be kept as consistent as possible. In particular, the trap current (or source current) should be used to regulate the filament current, so that the ionisation conditions in the source are stabilised.

Moreover, temperature distribution over the length of the filament is not uniform and may change over time. Therefore, obtaining a single measurement for filament temperature is not straightforward or reliable.

As a result, GB2551127 would benefit from an improved technique for keeping the filament temperature stable.

### SUMMARY

The present invention addresses the problem of fluctuations in the filament temperature during the non-ionization phase and proposes a solution to keep it stable, without the need to install a temperature sensor.

The filament current is regulated on the trap current readback. As the reduced electron energy also reduces the effective trap current, the filament current can be kept stable by choosing a lower trap current setpoint. Consequently, there is a specific trap current for each non-ionizing electron energy that will achieve a stable filament current. However, this trap current is not straightforward to identify. An automated calibration routine is therefore proposed by the invention. By reducing the trap current setpoint to the identified value, at the same time as reducing the electron energy, the filament temperature can be kept sufficiently stable.

A method of determining operational parameters of a spectrometer is provided. The spectrometer comprises an electron impact ion source operable in an on mode in which a first set of operational parameters are applied and an OFF mode in which a second set of operational parameters are applied. The first set of operational parameters comprises a first electron energy. The second set of operational parameters comprises a second electron energy. The method comprises the following steps:
a) introducing a sample of gas into the ion source, wherein the gas has an ionisation potential below the first electron energy and above the second electron energy;
b) operating the ion source in the ON mode and measuring a signal produced by ionisation of the sample of gas during a first time period;
c) operating the ion source in the OFF mode during a second time period;
d) determining, based on the signal measured during the first time period, an expected signal for ionisation of the sample of gas during a third time period;
e) operating the ion source in the on mode and measuring a signal produced by ionisation of the sample of gas during the third time period;
f) calculating a deviation between the measured signal for the third time period and the expected signal for the third time period;
g) based on the deviation, adjusting one or more parameters of the second set of operational parameters.

In contrast to the prior art, the proposed method provides a calibration routine for identifying operational parameters (e.g. a trap or source current setpoint) for the OFF mode by measuring under- or overshoot of the signal when the ion source is switched ON and selecting operational parameters to minimise the under- or overshoot. As a result of reducing the under or overshoot of the signal, a stable filament temperature is maintained during operation of the instrument, without needing to directly measure the filament temperature. Unlike GB2551127, no temperature sensors need to be added to the source.

This is important, as the source geometry of static mass spectrometers is optimized for sensitivity by reducing the source volume and surface area as much as possible. Including a sensor inside such a source would almost certainly require increasing its volume and/or surface area. Moreover, by providing a calibration routine that does not require new hardware for the spectrometer, new instruments can be manufactured using existing techniques and existing instruments can be easily updated to operate more effectively.

Moreover, in contrast to GB2551127, the instrument may be operated in ON and OFF modes, without the need to change the way in which the filament current is regulated. Filament current regulation will be on trap or source current, as is established technology.

The spectrometer may be a static gas mass spectrometer. Introducing the sample of gas into the ion source may comprise introducing a fixed volume of the gas into the ion source.

Introducing a sample of gas into the ion source may comprise operating the ion source in the OFF mode during introduction of the sample of gas. In other words, the ion source may be in the OFF mode while an inlet valve of the ion source is open.

Introducing a sample of gas into the ion source may further comprise operating the ion source in the OFF mode during an initial time period immediately following introduction of the sample gas. In other words, the ion source may remain in the OFF during an initial period, after the inlet valve of the ion source has been closed. Operating the ion source in the OFF mode during an initial time period may allow sufficient time for the gas to equilibrate within the ion source.

The time required for the gas to equilibrate within the ion source may depend on a number of factors including but not limited to the physical properties of the gas, the dimensions of the ion source, the conditions within the ion source and the like. As described in more detail below, the length of the initial period (and/or the duration of a period for which the ion source is kept open during introduction of the gas) may be selected so that when the ion source is turned to the ON mode, the signal measured by the spectrometer decreases over time.

The ion source may comprise a filament and a trap. A filament current may be regulated based on a trap current.

The ion source may further comprise an ionisation volume. The filament current may be regulated based on a source current comprising the trap current and a box current from the ionisation volume.

The filament current may be regulated to maintain a current setpoint for the trap current or the source current. The second set of operational parameters may comprise a current setpoint for the OFF mode. The first set of operational parameters may comprise a current setpoint for the ON mode.

Adjusting one or more of the second set of operational parameters in step “g” may comprise adjusting the current setpoint.

Adjusting the current setpoint may comprise decreasing the current setpoint if the measured signal for the third time period is lower than the expected signal for the third time period (current undershoot) and increasing the current setpoint if the measured signal for the third time period is higher than the expected signal for the third time period (current overshoot).

During the ON mode, it may be advantageous to regulate the filament current to keep the trap (or source) current constant so that the ionisation conditions within the ion source are kept constant. During the OFF mode, the filament current can continue to be regulated based on the trap current. However, a different trap (or source) current setpoint may be selected so that the problem of overshoot/undershoot is not observed. Advantageously, because the feedback mechanism for regulating the filament current is not decoupled between the ON and OFF modes, transient effects may be reduced.

The filament current may be regulated to maintain a current setpoint for the trap current or the source current during the ON mode. During the OFF mode, the filament current may be regulated to a set value. The second set of operational parameters may comprise the set value (the value at which the filament current should be maintained in the OFF mode). The filament temperature may be linked to the filament current. Therefore, the effects of undershoot and overshoot (which may be caused by fluctuations in temperature) may be reduced by keeping the filament current for the OFF mode at a set value and adjusting the set value so that overshoot/undershoot is reduced (rather than regulating the current in the OFF mode based on the source/trap current).

Adjusting one or more parameters of the second set of operational parameters based on the deviation may comprise identifying an initial deviation that changes over the course of the third time period to a final deviation, determining a difference between the initial deviation and the final deviation and adjusting one or more of the second set of operational parameters based on the difference.

Adjusting the current setpoint may comprise decreasing the current setpoint if the initial deviation for the third time period is lower than the final deviation for the third time period (current undershoot) and increasing the current setpoint if the initial deviation for the third time period is higher than the final deviation for the third time period (current overshoot).

Adjusting one or more parameters of the second set of operational parameters based on the deviation may comprise determining a gradient (slope) of the deviation over the third time period and adjusting one or more of the second set of operational parameters based on the gradient of the deviation. The parameters may be adjusted based on the initial gradient of the deviation.

Adjusting the current setpoint may comprise decreasing the current setpoint if the gradient of the deviation over the third time period is positive (current undershoot) and increasing the current setpoint if the gradient of the deviation over the third time period is negative (current overshoot).

The signal may represent an abundance of an isotope of the ionised gas.

Determining an expected signal for ionisation of the sample of gas during a third time period may comprise fitting the signal received during the first time period to an expected form, and time-shifting the fitted signal by the duration of the second time period.

The expected form may comprise a function that represents a decay of the signal over time. The expected form may be an exponential decay, which may be of the form f(t)=a exp (b t) or another appropriate form. Alternatively, fitting the signal to an expected form may comprise applying a linear or polynomial fit (such as a second order fit) to the signal received during the first time period. As will be appreciated by the skilled person, other possible functions may also be suitable for fitting to the signal.

Determining an expected signal for ionisation of the sample of gas during a third time period may further comprise adding an offset to the expected signal based on the duration of the second time period.

This offset may anticipate/compensate for an increase in the signal as a result of gas entering the ion source during the second time period. This increase in the signal is known as a rate of rise of the signal. The rate of rise may be caused by atmospheric gas entering the evacuated ion source via small leaks.

The method may further comprise determining a rate of the increase in the signal as a result of gas entering the ion source by:
evacuating the ion source;
operating the ion source in the OFF mode during a passive collection time period;
operating the ion source in the ON mode during a measurement time period;
determining, based on the signal measured during the measurement time period and a duration of the passive collection time period, a rate of the increase in the signal as a result of gas entering the ion source for.

Determining an expected signal for the sample gas during the third time period may be based on the signal measured during the first time period, the duration of the second time period, and the determined rate of rise.

The signal may be an isotope ratio of two isotopes of the ionised gas.

Determining an expected signal for ionisation of the sample of gas during a third time period may comprise fitting the isotope ratio over the course of the first time period to an expected form and determining an expected isotope ratio for the third time period.

Fitting the isotope ratio to an expected form may comprise deriving a linear fit. Determining an expected isotope ratio for the third time period may comprise determining an expected linear change in isotope ratio.

Using the expected form, the isotope ratio over the course of the first period may be extrapolated back to an initial isotope ratio at the time ionisation of the sample began. The expected isotope ratio for the third time period may be determined so that the isotope ratio for the third period can be extrapolated back to the same initial ratio (corrected to account for the period during which ionisation was switched to the OFF mode).

Adjusting one or more of the second set of operational parameters (step “g”) may comprise adjusting the one or more operational parameters (e.g. the current setpoint) by an offset determined based on a gradient of the deviation (e.g. using a function or lookup table).

Steps “a” to “g” may define a first cycle for adjusting one or more of the second set of operational parameters. The method may further comprise one or more further cycles for iteratively adjusting one or more of the second set of operational parameters. Each further cycle may comprise the following steps:
d′) determining, based on the signal measured during a first time period of the further cycle, an expected signal for ionisation of the sample of gas during a third time period of the further cycle;
c′) operating the ion source in the OFF mode during a second time period of the further cycle, wherein the adjusted second set of operational parameters are applied during the OFF mode of the further cycle (adjusted in the immediately preceding cycle);
e) operating the ion source in the ON mode and measuring a signal produced by ionisation of the sample of gas during the third time period of the further cycle;
f) calculating a deviation between the measured signal for the third time period of the further cycle and the expected signal for the third time period of the further cycle;
g) based on the deviation, adjusting one or more of the second set of operational parameters.

The first time period of the further cycle may be the third time period of an immediately preceding cycle (or at least part of the third time period of an immediately preceding cycle). In other words, the first time period of the further cycle and the third time period of an immediately preceding cycle may at least partially overlap.

Adjusting one or more parameters of the second set of operational parameters in step “g” may comprise adjusting one or more parameters according to a step size (e.g. as defined by a Newton-Raphson iteration method). A first adjustment step size may be defined during a first round iteration method. In other words, the adjustment step size is the same for each cycle in the first round of the iteration method. The first round may comprise the first cycle and optionally one or more immediately subsequent cycles.

The iteration method may further comprise one or more further rounds. Each further round may comprise a cycle for adjusting one or more of the second set of operational parameters that immediately follows a last of cycle of the previous round and optionally one or more immediately subsequent cycles. An adjustment step size for each cycle of the further round may be defined as a predetermined fraction of the adjustment step size of the immediately preceding round.

The predetermined fraction may be between 30% and 50%. Alternatively, the predetermined fraction may be anywhere between 0% and 100%. Particularly, the predetermined fraction may be 20%, 25%, 30%, 35%, 40%, 45% or 50%.

The iteration may be stopped after a predetermined number of cycles or rounds. Alternatively, the iteration may be stopped when a difference between the initial and final deviation is below a threshold (relative or absolute). Alternatively, the iteration may be stopped when a magnitude of the gradient of the deviation is below a threshold.

If a signal value below a predetermined threshold is detected (e.g. during step “e” of a cycle), an immediately subsequent cycle comprises steps “a” to “g” as defined above in relation to the first cycle. The adjusted second set of operational parameters are applied during step “c” of the cycle (adjusted in the immediately preceding cycle).

The method may further comprise determining a background signal (e.g. caused by contaminants) during the OFF mode of the ion source.

The method may further comprise operating the ion source in the OFF mode until the background signal falls below a threshold. Advantageously, the ion source may be operated in the OFF mode to consume the contaminants so that the proportion of the signal attributed to contaminants when the ion source is turned to the ON mode is reduced.

This may be advantageous after the calibration process is complete and the sample gas introduced to the ion source is gas from a sample for analysis, rather than a sample for the purposes of calibration.

A method of determining a rate of an increase in a signal (“rate of rise”) determined by a mass spectrometer is provided. The mass spectrometer comprises an electron impact ion source operable in an ON mode in which a first set of operational parameters are applied and an OFF mode in which a second set of operational parameters are applied. The first set of operational parameters comprises a first electron energy. The second set of operational parameters comprises a second electron energy. The method comprises the following steps:
evacuating the ion source;
operating the ion source in the OFF mode during a passive collection time period;
operating the ion source in the ON mode during a measurement time period;
determining, based on the signal measured during the measurement time period and a duration of the passive collection time period, a rate of rise of the spectrometer.

A method of determining a determining a background signal caused by contaminants in a mass spectrometer is provided. The mass spectrometer comprises an electron impact ion source operable in an ON mode in which a first set of operational parameters are applied and an OFF mode in which a second set of operational parameters are applied. The first set of operational parameters comprises a first electron energy. The second set of operational parameters comprises a second electron energy. The method comprises operating the ion source in the OFF mode and determining a signal caused by contaminants during the OFF mode of the ion source.

A method of purifying a sample in a mass spectrometer is provided. The mass spectrometer comprises an electron impact ion source operable in an ON mode in which a first set of operational parameters are applied and an OFF mode in which a second set of operational parameters are applied. The first set of operational parameters comprises a first electron energy. The second set of operational parameters comprises a second electron energy. The method comprises operating the ion source in the OFF mode, determining a background signal caused by contaminants during the OFF mode of the ion source, and operating the ion source in the OFF mode until the background signal falls below a threshold. Advantageously, the ion source may be operated in the OFF mode to consume the contaminants so that, when the ion source is turned to the ON mode, the proportion of the signal attributed to contaminants is reduced.

A mass spectrometer configured to perform a method as described above is also provided.

Computer software that, when executed by a processor of a computer, causes the computer to perform a method as described above is also provided.

### BRIEF DESCRIPTION OF THE DRAWINGS

FIG. 1 illustrates a simplified schematic of a static mass spectrometer.

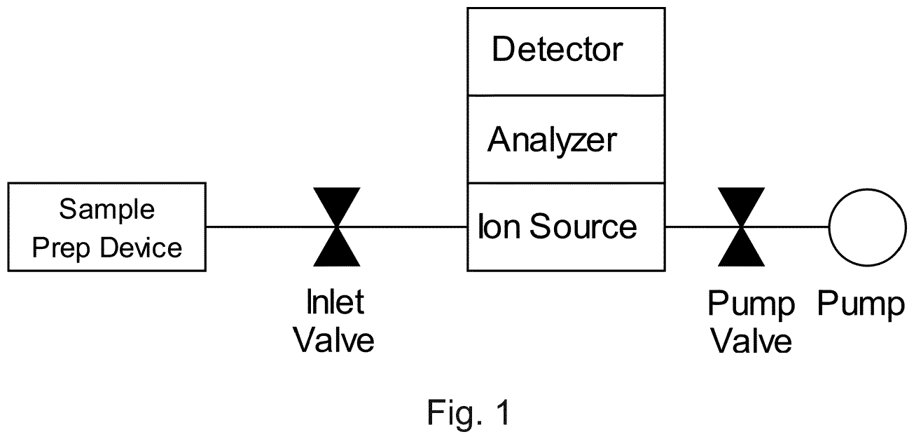

FIG. 2 illustrates a schematic of an ion source.

The invention is described in reference to a number of specific non-limiting examples illustrated in the Figures.

FIG. 3 illustrates a method of determining operational parameters of a mass spectrometer.

FIG. 4 illustrates signal overshoot and undershoot on a continuous flow mass spectrometer.

FIG. 5 illustrates an example signal for a static MS where the ion source is switched between ON and OFF mode.

FIG. 6 illustrates how under-/overshooting can be identified on a static MS in a more precise manner.

FIG. 7 illustrates how the deviation of an observed signal from an expected signal (shifted decay curve) changes during an ON period.

FIG. 8 illustrates the impact of the rate of rise on the observed signal.

FIG. 9 illustrates a method of finding the ideal trap current setpoint during the OFF phase by using a Newton-Raphson approximation.

FIG. 10 illustrates extrapolation of Isotope ratios measured during different ON phases to determine an initial isotope ratio.

### DETAILED DESCRIPTION

The present invention aims to identify two sets of operational parameters for an ion source of a mass spectrometer, the operational parameters being specific to analysis of a particular sample gas. A first set of operational parameters represents an “OFF” mode of the ion source. In the “OFF” mode, an Electron Energy of the ion source is less than an Ionisation Potential of the sample gas. A second set of operational parameters represents an “ON” mode of the ion source. In the “ON” mode, the Electron Energy of the ion source is less than the Ionisation Potential of the sample gas.

It should be noted that the filament of the ion source is not actually turned off during the “OFF” phase. Instead, the ion source is operated with different operational parameters that result in no ionisation of the sample. A reason that the ion source is not switched off completely is that transitional effects when turning the ion source back on would result in a stabilisation period during which useful measurements cannot be taken (but during which the sample may be consumed). In particular, it is desirable to maintain a constant filament temperature, which would not be possible if the ion source were switched off completely.

As explained above, it is advantageous to regulate a filament current of the ion source based on a trap current of the ion source. In this way, the trap current may be maintained at a specified value (the trap current setpoint) by adjusting the filament current. In doing so, stable ionisation conditions for the ion source may be provided.

If the trap current setpoint were the same for the ON and OFF modes, transition from the OFF mode to the ON mode would increase the Electron Energy, which would result in an initial increase in the trap current. The feedback loop would operate to stabilise the trap current at the trap current setpoint by reducing the filament current, which would cause an undesirable reduction in temperature of the filament. Therefore, it is desirable to provide a different trap current setpoint for the ON and OFF modes.

If the trap current setpoint for the OFF mode is lower than the trap current setpoint for the ON mode, a smaller correction may be required when the electron energy is increased than if the trap current setpoints were the same. There is therefore a theoretical trap current setpoint for the OFF mode that will result in no initial correction being required when the ion source transitions from the OFF mode to the ON mode. Using these parameters, there would be no significant change in filament temperature when transitioning between states, which would improve the performance of the ion source and lead to more reliable measurements with a smaller initial period of uncertainty.

It is a desired outcome of the calibration routine to provide operational parameters for the OFF and ON modes that result in a stable filament temperature when switching between modes. This may be achieved by defining an electron energy/I_{Trap} setpoint pair for the ON mode and choosing the correct corresponding electron energy/I_{Trap} setpoint pair for the OFF mode. For example, the operational parameters for the OFF mode may comprise a low electron energy and a low trap current setpoint. The operational parameters for the ON mode may comprise a high electron energy and a high trap current setpoint.

The ion source may be operated in the OFF mode during sample introduction. The sample is not consumed because the electron energy of the source is below the ionisation potential of the sample gas. Once the sample has equilibrated in the ion source, the ion source may be switched to the ON mode, in which the electron energy of the source is above the ionisation potential of the sample gas and the mass spectrometer may be used to obtain useful measurements for the sample gas.

The ionization efficiency is related to the filament temperature. Consequently, changes in the filament temperature are reflected in the measured signal of the mass spectrometer. As a result of changes in the filament temperature, fluctuations of the signal are observed until regulation of the trap current stabilizes the filament current again. These fluctuations are observed as overshooting or undershooting of the signal. These fluctuations in the signal can be used as a surrogate to infer fluctuations in the filament temperature.

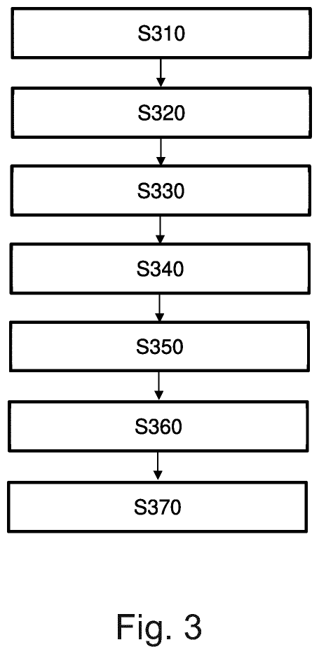

FIG. 3 illustrates a method of determining operational parameters of a mass spectrometer. The method comprises the following steps:
S310: introducing a sample of gas into the ion source, wherein the gas has an ionisation potential below the ON electron energy and above the OFF electron energy;
S320: operating the ion source in the ON mode and measuring a signal produced by ionisation of the sample of gas during a first time period;
S330: operating the ion source in the OFF mode during a second time period; S340: determining, based on the signal measured during the first time period, an expected signal for ionisation of the sample of gas during a third time period;
S350: operating the ion source in the ON mode and measuring a signal produced by ionisation of the sample of gas during the third time period;
S360: calculating a deviation between the measured signal for the third time period and the expected signal for the third time period;
S370: based on the deviation, adjusting one or more of the second set of operational parameters.

The physical principles that cause the effect of signal undershoot and overshoot when adjusting the electron energy of the ion source are equally applicable to both static and continuous flow mass spectrometers. The invention will now be described in relation to a Continuous Flow Mass Spectrometer (CF-MS). This is useful for illustrating the principle. However, a primary use of the invention is for static MS, rather than CF-MS. A reason for this is that providing an OFF mode is useful to prevent consumption of the sample where only a limited quantity of the sample is available (as is often the case for static MS).

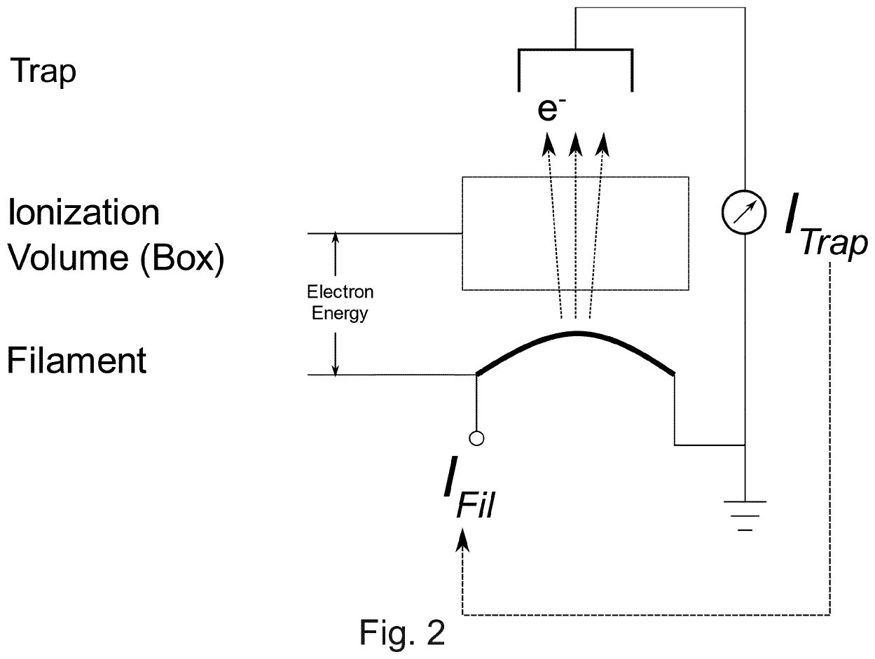

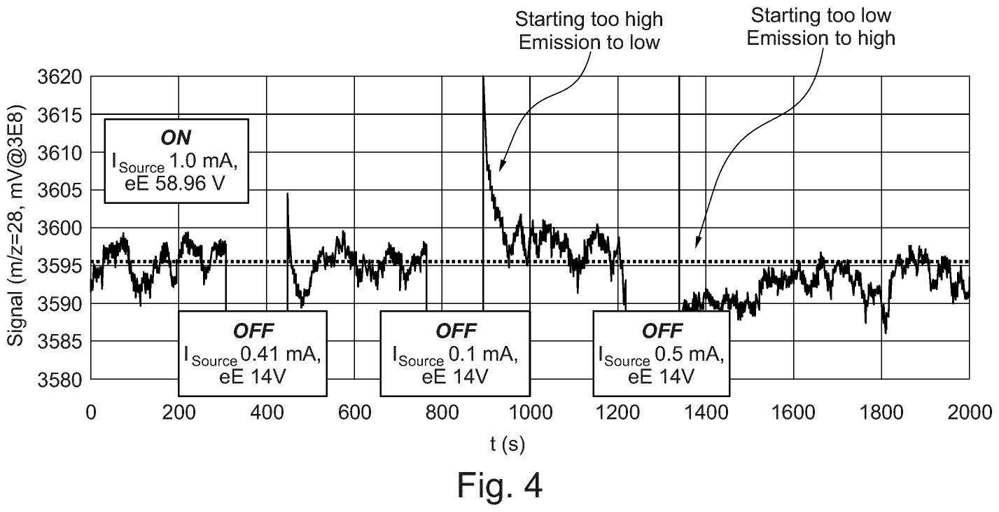

FIG. 4 illustrates signal overshoot and undershoot on a continuous flow mass spectrometer. The signal in FIG. 4 is a measured signal of nitrogen over time on a 253 Plus mass spectrometer (a continuous flow mass spectrometer). In this example, the filament current is regulated on the total source current, I_{Source} (where I_{Source}=I_{Trap}+box current, see FIG. 2), rather than on the trap current. Nitrogen is administered to the source continuously. Most of the time (“ON” phases), the electron energy is set to 58.96 eV at an I_{Source} setpoint of 1 mA. In several “OFF” phases, the electron energy is reduced below the ionization potential of N₂ (15.6 eV), causing the measured signal to drop to zero. When transitioning from the ON mode to the OFF mode, the I_{Source} setpoint is reduced at the same time as reducing the electron energy.

As can be seen from FIG. 4, a reduction of the I_{Source} setpoint for the OFF mode to 0.1 mA results in a pronounced overshooting of the signal when transitioning from the OFF mode to the ON mode, while a reduction of the I_{Source} setpoint to 0.5 mA for the OFF mode causes an undershooting of the signal when the source transitions to the ON mode. A signal which is almost immediately stable when changing between OFF and ON modes can be achieved between these two extremes, at I_{Source}=0.41 mA during the OFF mode.

The calibration routine aims to find the source current for the “OFF” state that results in a stable signal (in other words, no or negligible overshoot/undershoot of the signal when the source transitions from the OFF mode to the ON mode).

FIG. 4 illustrates a Nitrogen Signal on a 253 Plus IRMS over time, with ON phases during which the source gas is ionised and OFF phases without ionization (because of reduced electron energy, eE, during the OFF phases). Careful adjustment of the source current setpoint (I_{Source}) avoids over-/undershooting after switching ionization back to the ON mode.

Over- and undershooting of the signal also impacts isotope ratio. This is not surprising, as these arise from sudden changes in filament current and temperature, with the temperature affecting the ionization of isotopes differently. Stable isotope ratios can only be measured precisely with a stable signal after switching the ionization to the ON mode. Hence, the calibration routine needs to find the suitable source current during the “OFF” phase keeping the filament temperature stable and avoiding over- or undershooting of the signal.

As can be seen from FIG. 4, calibration can be achieved by starting with a low I_{Source} setpoint when going into the OFF mode and observing the overshooting after returning to the ON mode. The process is then repeated with slightly higher I_{Source} setpoint until overshooting is no longer observed.

Alternatively, calibration can be achieved by starting with a high I_{Source} setpoint when going into the OFF mode and observing the undershooting after return to the ON mode. The process is then repeated with slightly lower I_{Source} setpoint until undershooting is no longer observed.

Alternatively, calibration can be achieved by alternating between high and low I_{Source} setpoints when going into the OFF mode and observing over- or undershooting after returning to the ON mode. The process is then repeated with higher or lower I_{Source} setpoints until over- or undershooting is no longer observed.

The same principles as outlined above in relation to continuous flow MS also apply to a static MS. However, on static MS the signal depletes over time, rather than staying constant. The sample is administered once at the beginning of the measurement and then consumed by ionization. No sample is consumed during the OFF mode (the times when the ion source is OFF are referred to as OFF “phases”). This does not change the way in which the source or trap current setpoint for the OFF mode is determined. However, the way in which the data is handled during calibration is different for a static MS. This is at least because the expected steady state signal for continuous flow MS is constant, whereas the expected signal for a static MS is an exponential decay.

A first method for determining a source or trap current setpoint for the OFF mode is described below. This method is useful for determining an approximate value in a relatively short time frame (with relatively few iterations and/or where each ON and OFF phase is relatively short). This method is therefore referred to as a “coarse” method.

To find an approximate OFF trap current, a coarse method is provided in which a final signal measurement (intensity) before the OFF phase (the last measurement of the ON phase) is compared to the an initial signal measurement of the next ON phase (which may be the maximum signal measurement during that phase, as explained below). Assuming no sample consumption during the OFF phase, the intensities of these measurements should be the same, if the trap current setpoint during the OFF phase is set to the ideal value. To obtain measurements indicative of under- or overshoot, the mode of the ion source is switched between the ON mode and the OFF mode. During a first time period, t₁ (also referred to as an ON phase), the ion source is operated in the ON mode. During a second time period, t₂ (also referred to as an OFF phase), the ion source is operated in the OFF mode. During a third time period, t₃, the ion source is operated in the ON mode (and so on).

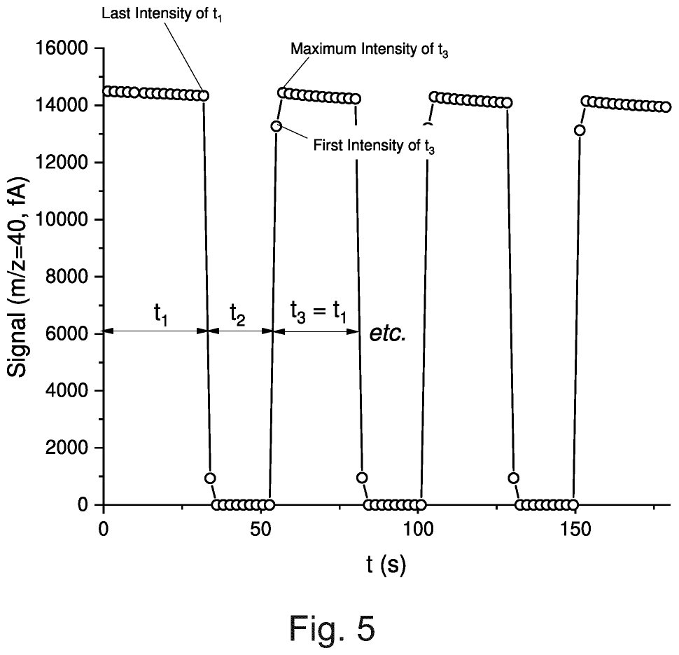

FIG. 5 illustrates an example signal for a static MS where the ion source is switched between ON and OFF mode. Any significant differences between the two intensities (final intensity of t₁ and initial intensity of t₃) can be used to calibrate the trap current setpoint, in accordance with the procedure outlined in relation to FIG. 4.

In practice, such a method may comprise the following steps:

Sample gas is introduced into the ion source and a signal measurement is started using the same electron energy and trap current setpoint (I_{Trap}) as are intended for analytical sample measurements (in other words, the ion source is operated in the ON mode).

After a first time t₁, the electron energy and trap current setpoint are reduced. The electron energy is chosen below the ionization potential of the sample species (in accordance with GB2551127, e.g., 12 eV for Ar). Ionisation of the sample gas therefore does not occur and the ion source is operating in the OFF mode. Typically, t₁ may be rather short, e.g., between 20 and 40 s.

The instrument is kept in the OFF mode for a time t₂, which may also be between 20 and 40 s.

After t₂, electron energy and trap current setpoint are increased back to the original settings as used in t₁ (in other words, the ion source is operated in the ON mode again) and the measurement is continued for a third time period t₃.

The last measured signal intensity of t₁ is compared to the initial intensity of t₃ (which may be the first intensity, the second intensity or the maximum intensity within t₃).

Depending on the outcome of the comparison, the trap current setpoint is readjusted.

The whole cycle is repeated. Re-introduction of sample gas is optional. Typically, the cycle is continued with the same gas in the source, in which case t₃ of the previous cycle is treated as t₁ of the next cycle. The variation in the signal over time is illustrated in FIG. 5.

The initial signal measurement for the t₃ ON phase may include the first few datapoints collected by the spectrometer during that t₃ ON phase, rather than only the first datapoint collected. At the end of t₂, electron energy and trap current are readjusted to measurement settings. However, after switching the ionization ON after t₂, the first intensity of t₃ is not yet at full signal. In practice, it takes between 1 and 5 sec until the signal “bounces back”. Therefore, instead of using the first obtained signal of t₃, which may be subject to these transient effects, the maximum signal within that time may be used to provide a more accurate measurement.

There is no “perfect” integration time for this mode. Using a short integration time (e.g., 5 s, or less) will result in pronounced noise, making the comparison of the two intensities difficult. On the other hand, for longer integration times, the data are increasingly affected by sample depletion. Consequently, the max. signal in t₃ has to be slightly lower than the last one in t₁. The integration time selected will be a trade-off between these two effects.

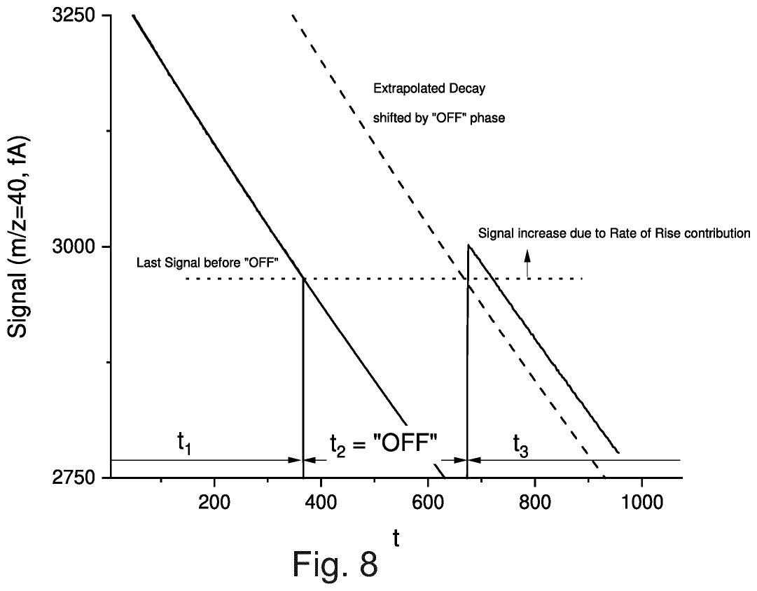

On static MS, the source is not pumped during measurement, including during the OFF phase, t₂. Small leaks in the source volume will cause an increase in the background signal. For example, atmospheric argon may diffuse into the ion source. This increase is measured as the “rate of rise” (ROR). Consequently, the intensity in t₃ may be slightly higher, at least if the instrument has a pronounced ROR or if a long t₂ time (OFF phase) is used. This effect may be corrected by determining the ROR beforehand and correcting the measured intensity in t₃ accordingly (see also FIG. 8):

$${I}_{corr} ( {t}_{3} ) = {I}_{raw} ( {t}_{3} ) - ROR \times {t}_{2}$$

Due to the considerations and limitations discussed above, and the fact that only one datapoint per ON phase (t₁, t₃ interval) is used, the precision of this coarse calibration procedure is limited. Another method for trap current calibration is described below. This method may yield a higher precision and is therefore referred to as a “fine” method. In some embodiments of the invention, the fast coarse method may be performed, followed by the slower fine method.

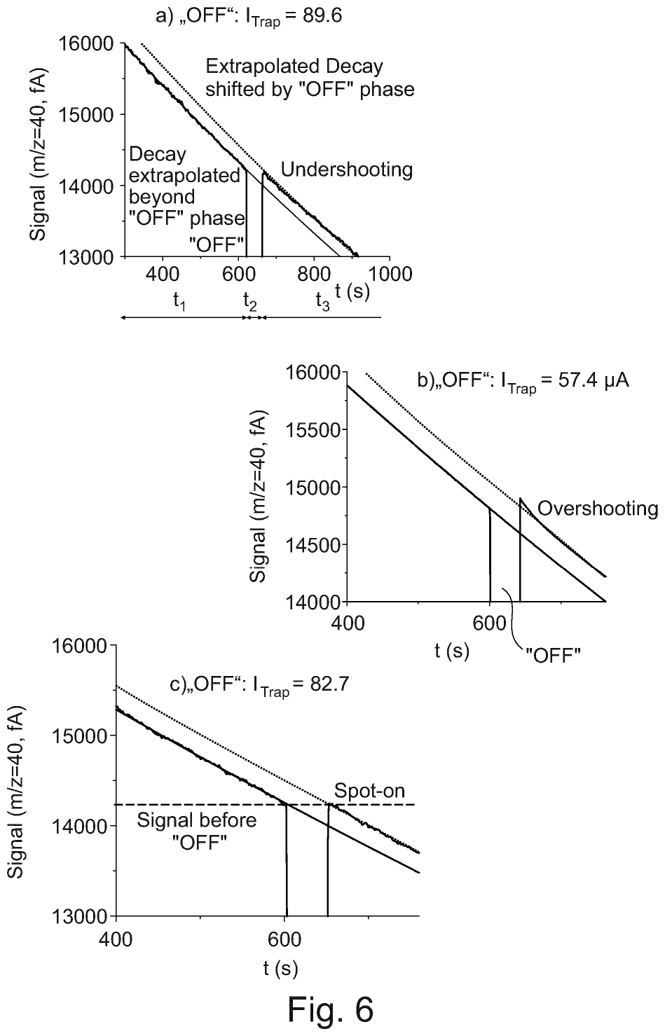

FIG. 6 illustrates how under-/overshooting can be identified on a static MS in a more precise manner. In the specific example illustrated in FIG. 6, Ar depletion scans in a static MS are illustrated. The operational parameters for the specific example illustrated in FIG. 6 are:

ON mode: electron energy 66 eV, I_{Trap} setpoint=205 μA.

OFF mode: electron energy 12 eV, I_{Trap} setpoint adjusted:
a) I_{Trap}=89.6 eV—undershooting below the shifted decay curve after switching ionization back to the ON mode,
b) I_{Trap}=57.4 eV—overshooting,
c) I_{Trap}=82.7—signal depletion following shifted decay curve after switching ionization back to the ON mode. Note that here, after switching back to the ON mode, the signal starts at the same level as the final level of the previous ON phase (just before ionization was switched to the OFF mode).

The method may comprise the following steps:

Sample gas is introduced into the ion source and a signal measurement is started using the same electron energy and trap current setpoint (I_{Trap}) as are intended for analytical sample measurements (in other words, the ion source is operated in the ON mode).

After a first time t₁, the electron energy and the trap current setpoint are reduced. The electron energy is chosen below the ionization potential of the sample species (in accordance with GB2551127, e.g., 12 eV for Ar). Ionisation of the sample gas therefore does not occur and the ion source is operating in the OFF mode. Typically, t1 may be substantially longer than in the coarse method described above. For example, t₁ may be in the range between 120 and 300 s.

The instrument is kept in the OFF mode for a time t₂, which may be between 20 and 300 s.

After the OFF phase t₂, the electron energy and trap current setpoint are increased back to the original setting as used in t₁ (ON mode parameters). Signal measurement is continued during an ON phase over a period t₃, which may be at least 20s.

An exponential decay in the form f(t)=a exp (b t) is fitted to the depleting signal for t₁ (illustrated as a solid line in FIG. 6).

This decay function is shifted in time by t₂ to provide the expected signal for t₃ (illustrated as a dotted line in FIG. 6). If no under-/overshooting is observed (if the trap current setpoint were set correctly), the decay during t₃ must follow the shifted decay curve. In other words, the observed (or “measured”) signal would match the expected signal.

Any deviation between the expected decay curve and the observed decay during t₃ can be attributed to under-/overshooting. Based on the observed under-/overshooting, the trap current setpoint for the OFF phase may be adjusted accordingly.

The whole procedure is repeated until the expected and observed decay curves are in agreement or the difference between the two is negligible (or minimised). As with the coarse mode, re-introduction of the sample gas is optional. Due to the longer total measurement time of the fine method, more gas will be consumed than in the coarse method, eventually prompting re-fills of the gas.

Over- or undershooting at the beginning of t₃ (the ON phase) can be identified by calculating the deviation between measured (observed) signal and shifted decay curve (expected signal). Over the course of the ON phase, the initial perturbation subsides and the signal settles towards the expected decay curve. A decrease in the deviation over time can be attributed to overshooting (i.e. the signal is too high to start with). Undershooting results in an increase in the deviation over time (bearing in mind that the deviation may be negative at the start of the ON phase because the signal is too low to start with). Consequently, the slope of the deviation provides a measure of over- or undershooting.

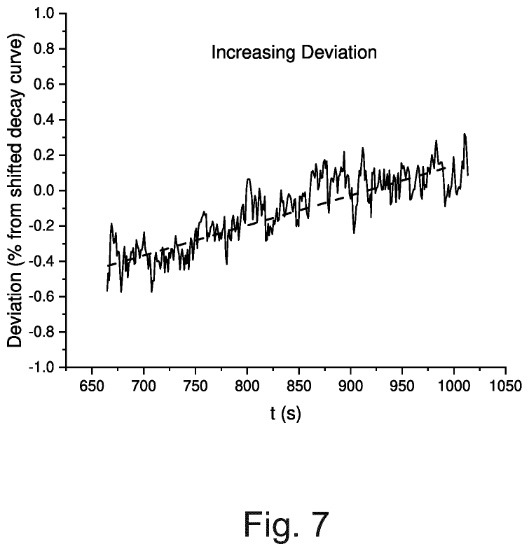

FIG. 7 illustrates the deviation of the observed signal from the expected signal (shifted decay curve) of FIG. 6a. The deviation may be expressed as an absolute deviation (e.g. observed signal-expected signal). Alternatively, the deviation may be expressed as a relative deviation (in %). For example, the deviation may be expressed as (a percentage of) the deviation from the expected signal. As discussed above, the expected signal is calculated by fitting a decay curve to the previous measurement, extrapolating the decay curve and time-shifting to account for the interval during which ionisation is switched OFF. The deviation between expected and observed signal results from the undershooting explained with reference to FIG. 6. The visible increase in the deviation over time from −0.4 to 0.0 (positive deviation slope) is due to the undershooting of the signal. Ideally (if the trap current setpoint for the OFF mode was correctly set and if there were no ROR), there would be no deviation between the measured signal and the shifted decay curve, only scatter (noise) around a deviation of zero, without any slope.

FIG. 8 illustrates the impact of the rate of rise. Due to argon diffusing into the ion source, the signal starts higher after the “OFF” phase. The observed decay in t₃ is parallel to the expected signal (the extrapolated shifted decay of t₁). The deviation calculated in this case would therefore be approximately constant over time during the observation period t₃, but not zero. Such a behaviour can be attributed the rate of rise of the instrument, as shown in FIG. 8. This result suggests that the instrument could be improved by removal of the causative leak. However, the identification of a constant deviation does not necessarily invalidate the calibration result. This is because it is the slope of the deviation that is indicative of undershooting/overshooting. A constant offset does not affect the slope.

To calibrate the instrument, the coarse method may be used or the fine method may be used. In some examples, both methods may be executed sequentially.

In one example, the coarse method may increase, or decrease the trap current during t₂ in a step size of 5 to 40 μA until one of the following happens:

A minimum is found for the difference between the last intensity of t₁ and the maximum intensity within t₃, independent of the absolute difference (success).

The difference between these intensities is substantially small, e.g., they differ by less than 1% or 0.5% (success).

The total height of the signal warrants a refill with gas.

Whether the trap current setpoint is decreased or increased depends only on the relationship of the two intensities. A higher intensity for t₃ (overshoot) warrants an increase in the trap current setpoint and a lower intensity for t₃ (undershoot) warrants a decrease in the trap current setpoint. Successful completion either ends the calibration altogether or starts the fine method.

The fine method may be performed after the approximate range for the trap current setpoint has been determined from the coarse method. Alternatively, the coarse method may be dispensed with and the fine method may be used without the coarse method.

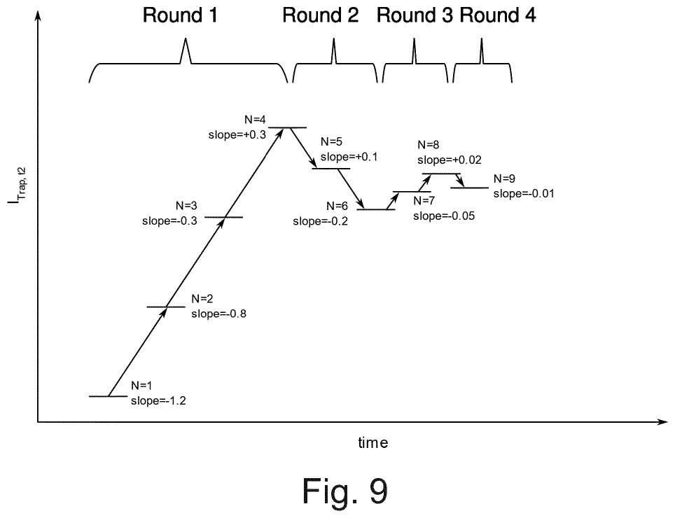

FIG. 9 illustrates a method of finding the ideal trap current setpoint during the OFF phase by using a Newton-Raphson approximation. Depending on the prefix (sign) of the measured slope, the trap current setpoint is readjusted until a minimal slope is found. This might be the trap current setpoint for the final Nth iteration of the last round but could also be at N−1, depending on the cycle for which the magnitude of the over-/undershoot is the least.

In one example, the fine mode uses a Newton-Raphson approximation to find the ideal trap current setpoint for the OFF mode. For the ideal trap current setpoint, minimal over- or undershooting of the signal occurs when the ion source is switched from the OFF mode to the ON mode. The fine method may comprise the following steps:

In a first round of the Newton-Raphson method, the trap current setpoint is increased or decreased using a first step size (which is 10 to 20 μA in this specific example). For each step, the slope of the deviation of the measured signal from the expected signal is calculated.

The trap current setpoint is adjusted in steps until the slope of the deviation crosses zero between steps. For example:

$$Slope ( N ) = 0.05 ,$$

$$Slope ( N + 1 ) = - 0.08$$

This zero-crossing indicates a reversal of the slope of the deviation. Therefore, an undershoot is observed at step N and an overshoot is observed at step N+1, as in the example provided above (or vice versa if the deviation is calculated the other way around as deviation=expected value−measured value). The ideal trap current setpoint therefore lies between the trap current setpoint used at step N and the trap current setpoint used at step N+1.

In a second round of the Newton-Raphson method, the procedure is repeated with a smaller step size, which may be between 30% and 50% of the step size used for the previous round (i.e., 4 to 8 μA for this specific example). The sign of the step size may be inverted between rounds. In other words, if the previous round increased the trap current setpoint until a zero crossing of the deviation slope is observed then this round may decrease the trap current setpoint (using a smaller step size) until a zero crossing of the slope of the deviation is observed.

The procedure is repeated for further rounds, each round having a smaller step size of 30% to 50% of the step size used for the previous round. In this specific example, a step size of 1.6 to 3.2 μA is used for the third round and the method is continued until a zero-crossing of deviation slope is observed. Then the procedure is repeated with a smaller step size of 30% to 50% of the one used for the third cycle, which is 0.64 to 1.28 μA for the fourth round and the method is continued until a zero-crossing of deviation slope is observed.

Optionally, further cycles may be performed. The ideal trap current setpoint causes the minimal deviation slope when the ion source is switched from the OFF mode to the ON mode. After execution of a pre-defined number of rounds (or cycles), the trap current setpoint having the smallest deviation slope may be selected. The smallest slope is the slope having the smallest magnitude (ignoring whether to slope is positive or negative).

In the specific example above, the deviation is calculated as:

$$deviation = measured value - expected value$$

In this specific example, if the slope of the deviation is greater than zero (as illustrated in FIG. 7) an undershoot of measured signal is observed (as illustrated in FIG. 6a). In this case, the current setpoint (trap or source current setpoint) may be decreased to correct the undershoot. On the other hand, if the slope of the deviation is less than zero (i.e. the deviation decreases over time) then overshoot is observed (as illustrated in FIG. 6b). In this case, the current setpoint may be increased to correct the overshoot. Of course, the expression for the deviation could be reversed (deviation=expected value-measured value) and the required adjustments to the current setpoint would also be reversed.

To summarise the iteration process illustrated in FIG. 9:
An overshoot is observed during the first cycle (N=1). Therefore, the current setpoint is increased by the first step size.
During cycles 2 and 3, an overshoot is observed and the iteration continues by increasing the current setpoint by the first step size.
At cycle 4, an undershoot is observed. The gradient of the slope has crossed zero. Therefore, the first round of the iteration is complete. For the second round, the step size is decreased and the sign of the step is inverted. In other words, the current setpoint is decreased between cycles 4 and 5 by the new step size (to correct the undershoot observed during cycle 4).
During cycle 5, an undershoot is observed, therefore, the setpoint is decreased again.
During cycle 6, an overshoot is observed. The gradient of the slope has crossed zero. Therefore, the second round of the iteration is complete. For the third round of the iteration, the step size is decreased again and the sign of the step is inverted again (so the current setpoint is increased between cycles 6 and 7 to correct the overshoot observed during cycle 6).
During cycle 7, an overshoot is observed, therefore, the setpoint is increased again.
During cycle 8, an undershoot is observed. The gradient of the slope has crossed zero. Therefore, the third round of the iteration is complete. For the fourth round, the step size is decreased and the sign of the step is inverted. In other words, the current setpoint is decreased between cycles 8 and 9 by the new step size (to correct the undershoot observed during cycle 8).
During cycle 9, an overshoot is observed. The gradient of the slope has crossed zero. Therefore, the fourth round of the iteration is complete. The process is complete at this stage because the maximum number of rounds has been reached. The magnitude of the slope is smallest at N=9. Therefore, the operational parameters for N=9 are selected for operation of the ion source in the OFF mode.

Rather than by performing a predetermined number of rounds, the method may be stopped when a deviation slope having a magnitude below a certain threshold is observed. The trap current setpoint causing this deviation slope during calibration may be selected for the OFF mode during operation of the instrument.

Instead of using an abundance signal for a particular isotope of the sample to determine operational parameters for the OFF mode, another embodiment uses a measured isotope ratio of the sample species. This could be the ratio ⁴⁰Ar/³⁶Ar. This ratio should be (more or less) unaffected by the “OFF” phase. In a more precise description, the isotope ratio changes during depletion of the sample in a linear fashion. After extrapolating the ratio back to the ratio at to, the linear function for t₁ and the linear function for t₃ should result in the same initial isotope ratio (because they are measurements of the same sample of gas at different times). Importantly, because the ratio is unaffected by the OFF phase, extrapolation for t₁ (the first ON period) is carried out to determine the ratio at t₀=0, whereas the extrapolation for t₃ (the second ON period) should be carried out to determine the ratio at a time-shifted version of t₀=0+t₂.

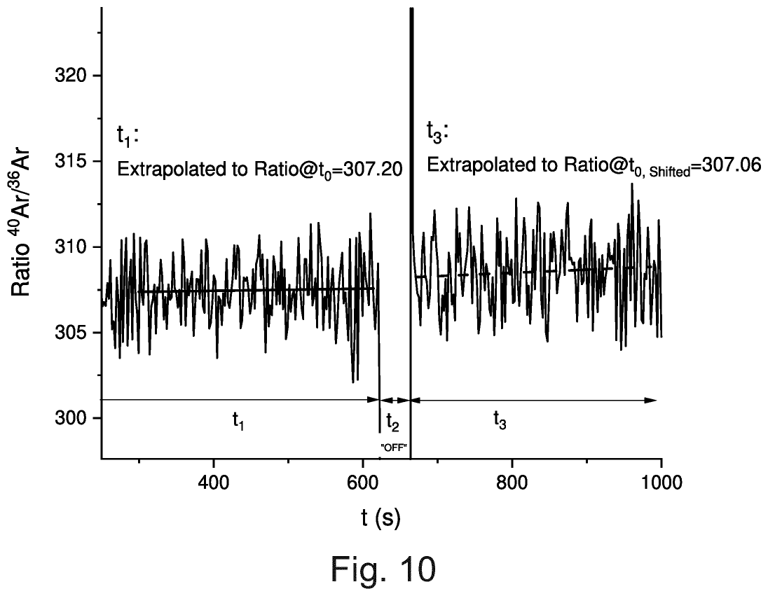

FIG. 10 illustrates extrapolation of Isotope ratios back to t₀, where the isotope ratios are measured during different ON phases: t₁ and t₃.

Methods described above iterate towards an ideal trap current setpoint during for the OFF mode, with minimal over- or undershoot, when the ion source is switched ON. Instead of iterating using predetermined steps of reducing size, a calibration table or function may be provided to determine a variable adjustment size. This would provide an expected adjustment for the trap current setpoint, given a deviation slope. By providing a variable adjustment size, calibration may be performed using only one cycle of measuring the deviation slope when the ion source is switched ON. Alternatively, more than one cycle may be performed with a variable adjustment determined based on the deviation slope after each round. In this way, adjusting the setpoint by a variable amount defined by tables or function may cause the setpoint to tend towards the ideal value more quickly than using an iterative method with a fixed step size (that decreases between rounds).

For example, for a measured deviation slope of −0.5 measured at a certain trap current setpoint, the ideal trap current setpoint may be expected to be 30 μA higher. As outlined above, this may be provided as a table, linking a range of slopes to expected adjustments required to approach the ideal trap current setpoint. An example table is provided below:

| Dev. Slope | Offset I_{Trap} |
|---|---|
| −2 to −1.5 | +10 |
| −1.49 to −1.1 | +7 |
| −1.09 to −0.5 | +3 |
| −0.49 to −0.05 | +1 |
| 0.05 to 0.62 | −1 |
| etc. | |

Alternatively, a mathematical function could be provided to calculate the adjustment from the deviation slope. In any case, a measured deviation slope would prompt the increase or decrease of the trap current setpoint by the associated adjustment. This approach may not be as accurate as the fine mode outlined above but could be a faster alternative to the coarse mode. Therefore, a variable step size may be used for an initial (coarse) calibration and then a fixed step size (decreasing between rounds) may be used for a subsequent (fine) calibration.

In an alternative example, keeping the filament current constant during the OFF phase might also keep the filament temperature stable, at least over a short interval. In this case, the last filament current before the OFF phase (based on regulation of the trap or source current) is kept fixed throughout this phase (regardless of fluctuations in the trap or source current). This embodiment is advantageously easy to implement. However, decoupling the feedback loop (setting the filament current based on the trap current) may have undesirable consequences. Slight changes in filament current over time are expected and observed, especially after the introduction of a sample and over long periods. Therefore, enforcing a fixed filament current during the OFF phase result in might create undesirable fluctuations in filament temperature.

In addition to the calibration methods provided for determining operational parameters during an OFF phase of the ion source, a method for more precisely determining the rate of rise of the instrument than the established procedure is also provided.

Existing methods for determining ROR for an instrument may involve the following steps:
Close the source sample inlet valve
Evacuate the ion source
Close off the source pump
Calculate ROR from signal increase over time (unit may be fA/s).

One downside is that, on a conventional static MS, the gas causing the ROR is inevitably consumed by ionisation during measurement, at the same time as it is leaking into the ion source. As the ionization discriminates between isotopes, no undisturbed information on the isotopic composition is readily accessible.

Another downside is, that the ROR signal will typically be rather small, at least for a well-prepared instrument. Consequently, the small, measured intensities will come with large uncertainties.

Another way to determine the ROR is therefore proposed:
Set the operational parameters of the ion source to non-ionizing conditions (turn the ion source to the OFF mode)
Close the sample inlet valve
Evacuate the ion source
Close off the ion pump
Wait (for 60s to 3600s, for example)

Set the ion source to the ON mode (ionizing conditions) and measure the signal produced by the gas collected in the source while waiting, using established protocols for static MS.

This will give a more precise measure of the amount and isotopic composition of contaminant gas leaking into the source.

As an option, a quality control check may be performed regularly after a measurement. For this purpose, the calibration method described above is repeated after a sample measurement. The data obtained during measurement of the sample can be utilized as t₁ data for this purpose, so no repeated measurement is necessary. The quality control check would than turn the ionization OFF for a period t₂ (such as 20s to 60s), and continue measuring for t₃ (such as approx. 100s) with ionization ON. Data collected during t₁ and t₃ would be evaluated against each other as described above (for the fine mode). If the data obtained during t₃ differs from the expected data (the shifted decay curve) by more than a predetermined threshold (such as 0.2% to 0.5%), a repetition of the calibration may be warranted.

One advantage of this implementation is that it does not take much extra time than a standard measurement. This is because the proposed quality control method uses data from the actual measurement that is performed (during t₁). Hence, quality control can be performed regularly (every sample, every 10th sample, once per day) without significantly compromising sample throughput.

Depending on the purity of the samples employed, a significant contribution of the signal may arise from contaminants, like hydrocarbons and other volatile organic compounds. The ionization potentials of the contaminants are typically in the range of 10 to 13 eV and substantially lower than those of most noble gases. By setting the ion source to the OFF mode, direct measurement of the signal caused by these contaminants in the absence of a noble gas signal may be performed. For example, in order to determine the contribution of hydrocarbons to the measured signal of argon (Ionisation Potential=15.8 eV), the electron energy would be set to 14 eV (turning the ion source to the “OFF” mode for measurement of Argon) and the trap current setpoint adjusted as described above. As Ar is no longer ionized, the remaining signal could be attributed to the contaminants.

This mode of background measuring mode may be especially useful for the minor isotopes, such as ³⁹Ar, which are easily interfered by fragment molecular ions of the same mass.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an ion multipole device) means “one or more” (for instance, one or more ion multipole device). Throughout the description and claims of this disclosure, the words “comprise”, “including”, “having” and “contain” and variations of the words, for example “comprising” and “comprises” or similar, mean “including but not limited to”, and are not intended to (and do not) exclude other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise.

All of the aspects and/or features disclosed in this specification may be combined in any combination, except combinations where at least some of such features and/or steps are mutually exclusive. As described herein, there may be particular combinations of aspects that are of further benefit, such the combination of certain pre-processing steps with certain algorithms. In particular, the preferred features of the disclosure are applicable to all aspects of the disclosure and may be used in any combination. Likewise, features described in non-essential combinations may be used separately (not in combination).

1. A method of determining operational parameters of a spectrometer, wherein the spectrometer comprises an electron impact ion source operable in an ON mode in which a first set of operational parameters are applied and an OFF mode in which a second set of operational parameters are applied, wherein the first set of operational parameters comprises a first electron energy and wherein the second set of operational parameters comprises a second electron energy, the method comprising:
a) introducing a sample of gas into the ion source, wherein the gas has an ionisation potential below the first electron energy and above the second electron energy;
b) operating the ion source in the ON mode and measuring a signal produced by ionisation of the sample of gas during a first time period;
c) operating the ion source in the OFF mode during a second time period;
d) determining, based on the signal measured during the first time period, an expected signal for ionisation of the sample of gas during a third time period;
e) operating the ion source in the ON mode and measuring a signal produced by ionisation of the sample of gas during the third time period;
f) calculating a deviation between the measured signal for the third time period and the expected signal for the third time period; and
g) based on the deviation, adjusting one or more of the second set of operational parameters.

2. The method of claim 1, wherein the spectrometer is a static gas mass spectrometer, wherein introducing the sample of gas into the ion source comprises introducing a fixed volume of the gas into the ion source.

3. The method of claim 2, wherein introducing a sample of gas into the ion source comprises operating the ion source in the OFF mode during introduction of the sample of gas.

4. The method of claim 3, wherein introducing a sample of gas into the ion source further comprises operating the ion source in the OFF mode during an initial period immediately following introduction of the sample of gas.

5. The method of claim 1, wherein the ion source comprises a filament and a trap, wherein a filament current is regulated based on a trap current.

6. The method of claim 5, wherein the ion source further comprises an ionisation volume and wherein the filament current is regulated based on a source current comprising the trap current and a box current from the ionisation volume.

7. The method of claim 5, wherein the filament current is regulated to maintain a current setpoint for the trap current or the source current, wherein the second set of operational parameters comprise the a current setpoint for the OFF mode.

8. The method of claim 5, wherein the filament current is regulated to maintain a current setpoint for the trap current or the source current during the ON mode, wherein the filament current during the OFF mode is regulated to a set value, wherein the second set of operational parameters comprises the set value.

9. The method of claim 1, wherein adjusting one or more of the second set of operational parameters based on the deviation comprises identifying an initial deviation that changes over the course of the third time period towards a final deviation, determining a difference between the initial deviation and the final deviation and adjusting one or more of the second set of operational parameters based on the difference.

10. The method of claim 1, wherein the signal represents an abundance of an isotope of the ionised sample of gas.

11. The method of claim 1, wherein determining an expected signal for ionisation of the sample of gas during a third time period comprises fitting the signal received during the first time period to an expected form, and time-shifting the fitted signal by a duration of the second time period.

12. The method of claim 11, wherein the expected form comprises a function that represents a decay of the signal over time, preferably an exponential decay, more preferably an exponential decay of the form f(t)=a exp (b t).

13. The method of claim 1, wherein determining an expected signal for ionisation of the sample of gas during a third time period further comprises adding an offset to the expected signal based on a duration of the second time period to compensate for an increase in the signal as a result of gas entering the ion source during the second time period.

14. The method of claim 1, further comprising determining a rate of an increase in the signal as a result of gas entering the ion source by:
evacuating the ion source;
operating the ion source in the OFF mode during a passive collection time period;
operating the ion source in the ON mode during a measurement time period; and
determining, based on the signal measured during the measurement time period and a duration of the passive collection time period, a rate of the increase in the signal as a result of gas entering the ion source for.

15. The method of claim 1, wherein the signal represents an isotope ratio of two isotopes of the ionised sample of gas.

16. The method of claim 1, wherein determining an expected signal for ionisation of the sample of gas during a third time period comprises fitting an isotope ratio over the course of the first time period to an expected form and determining an expected isotope ratio for the third time period, wherein fitting the isotope ratio to an expected form preferably comprises deriving a linear fit, and wherein determining an expected isotope ratio for the third time period preferably comprises determining an expected linear change in isotope ratio.

17. The method of claim 1, wherein adjusting one or more of the second set of operational parameters comprises adjusting the one or more operational parameters by an offset determined based on a gradient of the deviation.

18. The method of claim 1, wherein steps “a” to “g” define a first cycle for adjusting one or more of the second set of operational parameters, wherein the method further comprises one or more further cycles for iteratively adjusting one or more of the second set of operational parameters, each further cycle comprising to following steps:
d′) determining, based on the signal measured during a first time period of the further cycle, an expected signal for ionisation of the sample of gas during a third time period of the further cycle, wherein the first time period of the further cycle is the third time period of an immediately preceding cycle;
c′) operating the ion source in the OFF mode during a second time period of the further cycle, wherein the adjusted second set of operational parameters are applied during the OFF mode of the further cycle;
e) operating the ion source in the ON mode and measuring a signal produced by ionisation of the sample of gas during the third time period of the further cycle;
f) calculating a deviation between the measured signal for the third time period of the further cycle and the expected signal for the third time period of the further cycle; and
g) based on the deviation, adjusting one or more of the second set of operational parameters.

19. The method of claim 18, wherein adjusting one or more of the second set of operational parameters in step “g” comprises adjusting one or more of the second set of operational parameters according to an adjustment step size,
wherein a first adjustment step size is defined during a first round of an iteration method, wherein the first round comprises the first sample fill cycle for adjusting one or more of the second set of operational parameters and optionally one or more immediately subsequent further cycles,
wherein the iteration method further comprises one or more further rounds, wherein each further round comprises a cycle for adjusting one or more of the second set of operational parameters that immediately follows a last of cycle of the previous round and optionally one or more immediately subsequent cycles, and wherein an adjustment step size for each cycle of the further round is defined as a predetermined fraction of the adjustment step size the immediately preceding round.

20. The method of claim 19, wherein the predetermined fraction is between 30% and 50%.

21. The method of claim 18, wherein the iteration is stopped after a predetermined number of cycles.

22. The method of claim 18, wherein the iteration is stopped when a difference between an initial deviation and a final deviation for a cycle is below a threshold.

23. The method of claim 18, wherein, if a signal value below a predetermined threshold is detected during a cycle, an immediately subsequent cycle comprises steps “a” to “g”, as defined in claim 1.

24. The method of claim 1, further comprising determining a background signal caused by contaminants during the OFF mode of the ion source.

25. The method of claim 24, further comprising operating the ion source in the OFF mode until the background signal falls below a threshold.

26. A mass spectrometer configured to perform the method of claim 1.

27. A computer-readable storage having stored thereon computer-executable instructions that, when executed by a processor, cause the processor to perform the method of claim 1.
